(19) United States
(12) Patent Application Publication
(10) Pub. No.: US 2003/0121718 A1
(43) Pub. Date: Jul. 3, 2003

(54) Diaphragm suspension assembly for loudspeaker transducers

(76) Inventors: Brendon Stead, Thousand Oaks, CA (US); Mark Trainer, Stevenson Ranch, CA (US); Clayton Williamson, Moorpark, CA (US)

Correspondence Address: Squire, Sanders & Dempsey L.L.P., 14th Floor, 801 S. Figueroa Street, Los Angeles, CA, 90017-5554, US

(21) Appl. No.: 10/033,652

(22) Filed: Dec. 27, 2001

(51) Int. Cl. H04R 7/00; G10K 13/00

(52) U.S. Cl. 181/172; 181/171

(57) ABSTRACT

This invention provides a transducer having at least two surrounds supporting a cylinder. With at least two surrounds, the transducer may handle more power. This increased power may be used to drive the voice coil that is wrapped around the cylinder enabling a greater excursion range of the diaphragm. With a greater excursion range, the transducer may operate at low frequency as well as mid to high frequencies. The two surrounds may also be coupled to the cylinder increasing stability of the cylinder. With the two suspensions stabilizing the cylinder, the side-to-side movement of the cylinder may be reduced minimizing the chance of the voice coil short-circuiting with the other electrical and/or mechanical circuits in the transducer. In addition, the cylinder made a substantially rigid material may better support the two flexible surrounds so that the two surrounds do not induce wobbling in the diaphragm.

### 1. INCORPORATION BY REFERENCE OF A RELATED APPLICATION

This application incorporates by reference U.S. Provisional application serial No. 60/279,314 entitled “Tangential Stress Reduction in a Surround Speaker” filed on Mar. 27, 2001.

### BACKGROUND OF THE INVENTION

2. Field of the Invention

This invention relates to a dual suspension configuration for a loudspeaker transducer. In particular, this invention is well suited for use in space-constrained applications.

3. Related Art

In the design of miniature loudspeakers, there is usually a tradeoff between the size of the loudspeaker and its performance. As the size of the loudspeaker gets smaller, its ability to generate bass sound at low frequencies may be diminished because a smaller loudspeaker acting as a piston may not be able to “pump” a large volume of air to generate bass sound. This pumping or displacement volume of air is a product of the diaphragm's area and the amplitude of its excursion range. In particular, as the size of the transducer gets smaller there may be certain physical limitations as to the excursion range of the diaphragm. For instance, a transducer with one surround suspension may not be able to handle the delivered power driving the diaphragm to a higher excursion.

In many instances, a “woofer” may be provided with miniature loudspeakers to provide a full range of frequency response. The woofer for low frequency response, and the miniature loudspeakers for mid to high frequency response. Including a woofer into a speaker system, however, adds to the cost of the speaker system. When such miniature loudspeakers are incorporated into a laptop computer, the miniature loudspeakers alone cannot respond to a full range of frequencies without the woofer.

Another problem with transducers is wobbling of the diaphragm. This may degrade the acoustic sound produced by the diaphragm. A diaphragm should be light and as stiff as possible so that the residence frequencies may be high. Conversely, the suspension supporting the diaphragm should be flexible or as soft as possible so that it does not resist the oscillation movement of the diaphragm. But when a stiff diaphragm is surrounded by a flexible suspension, the diaphragm acts like a wobbling member rather than acting like a stiff member. Such wobbling can induce not only unwanted vertical movement of the diaphragm but also lateral or horizontal movements, which hinders the performance of the loudspeaker. Therefore, there still is need for a loudspeaker that can minimize the wobbling and respond to a full range of frequencies.

### SUMMARY

This invention provides a loudspeaker system employing at least two surrounds to support the cylinder housing the diaphragm in a transducer mount. By incorporating at least two surrounds, the transducer may handle increased power loads enabling a larger excursion range of the diaphragm. With a greater excursion range, the loudspeaker may increase its operational range to include low frequencies as well as mid to high frequencies. This way, the loudspeaker may operate as a full range loudspeaker and the two surrounds that may be coupled to the cylinder may act to increase stability of the cylinder. With the two suspensions stabilizing the cylinder, side-to-side movement of the cylinder may be minimized reducing the chance of a short circuit from occurring between the voice coil and the electrical circuits in the transducer. In addition, the cylinder composition may include a substantially rigid material assisting the two flexible surrounds in the reduction of wobbling of the diaphragm.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The invention can be better understood with reference to the following figures. The components in the figures are not necessarily to scale, emphasis instead being placed upon illustrating the principles of the invention. Moreover, in the figures, like reference numerals designate corresponding parts throughout the different views.

FIG. 1 is a top view of a diaphragm.

FIG. 2 is a side view of a transducer housing.

FIG. 3 is a cross-sectional view of a transducer.

FIG. 4 is a close-up cross-sectional view of the encircled region of FIG. 3.

FIG. 5 is a cross-sectional view of a transducer with parabolic cross-sectional shaped surrounds.

FIG. 6 is an enlarged, cross-sectional view of the parabolic surround.

FIG. 7 is a cross-sectional view of a transducer.

FIG. 8 is a cross-sectional view of a transducer.

FIG. 9 is a cross-sectional view of a transducer with an alternative surrounds location.

FIG. 10 is a cross-sectional view of a transducer illustrating another surrounds location.

FIG. 11 is a schematic diagram representing the spring constants of the surrounds.

FIG. 12 is a schematic diagram representing the dual surround relative to the center of mass.

FIG. 13 is a cross-sectional view of a transducer.

FIG. 14 is a perspective view of a diaphragm.

### DETAILED DESCRIPTION OF THE PREFERRED EMBODIMENTS

This invention may be suitable for application of the transducer in small enclosures. Such enclosures include application in small “surround sound” speaker systems, multimedia speaker systems (audio systems coupled to computers) and automotive speaker system.

FIG. 1 illustrates a top view of a transducer 100 including a diaphragm 102 coupled to a cylinder 104 designed to vibrate up and down within a housing 108. To guide the cylinder 104, a first surround suspension 106 and a second surround suspension (not shown here) may be between the cylinder 104 and the housing 108. The two suspensions 106 and 108 substantially stabilize the cylinder as it moves up and down. Extending from the housing 108 may be a pair of hookup wires 110 to provide power to the transducer 100. In one example, the diaphragm 102 may be disposed within the cylinder 104.

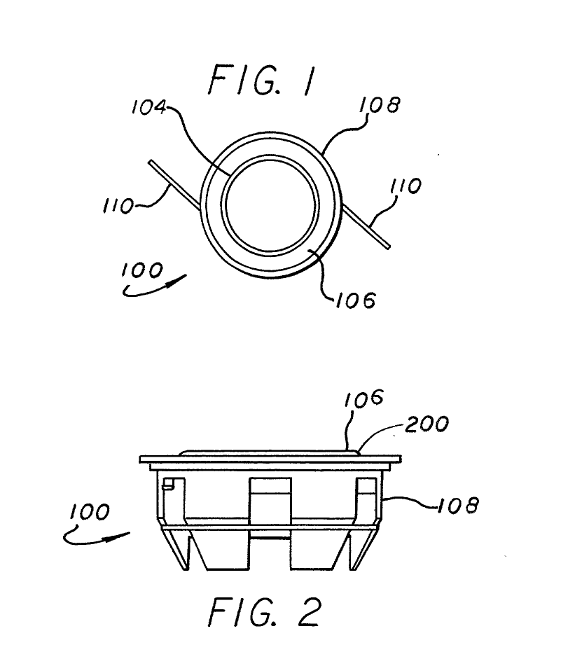

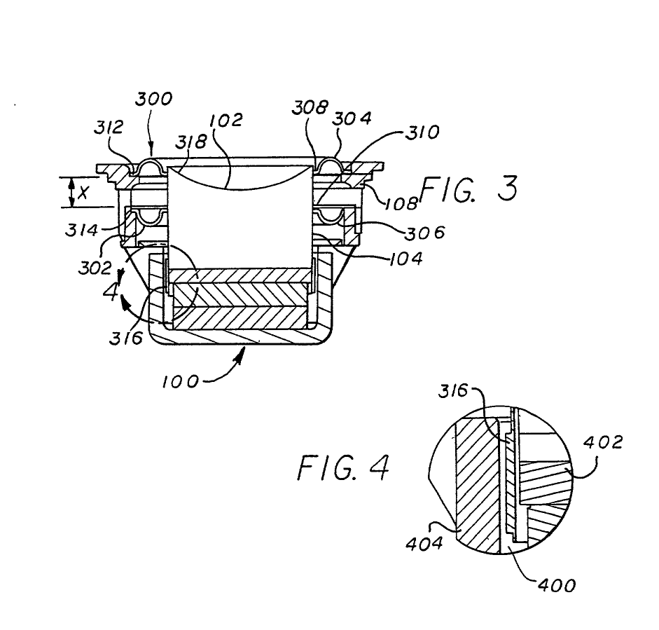

FIG. 2 is a side view of the transducer 100 with a roll 200 of the first surround 106 protruding from the housing 108. FIG. 3 illustrates a cross-sectional view of the transducer 100 having a first surround suspension 300 (first surround) and a second surround suspension 302 (second surround) at a predetermined distance “X” from each other. The diaphragm 102 may be concave and positioned on the upper edge 318 the cylinder 104. However, the diaphragm 102 may have other shapes as well, such as convex or any other type of diaphragm known to one ordinarily skilled in the art. The edge of the diaphragm 102 may have a flat narrow flange that is adhesively attached to the upper edge 318 of the cylinder 104. The two surrounds 300 and 302 may be located between the cylinder 104 and the housing 108. The two surrounds may symmetrically oppose each other such that the respective rolls 304 and 306 for each of the surround 300 and 302 may face away from each other. The inner edges 308 and 310 of the respective two surrounds 300 and 302 may be adhesively attached to the cylinder 104. The inner edge 308 of the first surround may be below the upper edge 318 of the cylinder 104. The outer edges 312 and 314 of the respective two surrounds 300 and 302 may be coupled to the housing 108.

A voice coil 316 may wrap around the cylinder 104 showing a cylindrical cross-sectional shape. The voice coil 316 may have a corresponding cylindrical shape as it wraps around the cylinder 104. The cylinder 104 and the voice coil 316 may have other cross-sectional shape as well, such as elliptical and triangular cross-sections. The voice coil 316 may include a pair of semicircular ends and a pair of straight edges connecting the pair of semicircular ends. That is, the shape of the voice coil 316 may be any type known to one skilled in the art. The two hookup wires 110 may extend outwardly through the housing 108 between the two surrounds 300 and 302. In such a case, the distance X between the two surrounds may be predetermined so that the two surrounds may move up and down within the housing 108 without damaging or touching the two hookup wires 110. Alternatively, the two wires 110 may run between the second surround 302 and the voice coil 316.

FIG. 4 is an enlarged view of the encircled area of FIG. 3, illustrating the voice coil 316 within a magnetic gap 400 between an upper pole piece 402 and a pot 404. As electrical signals pass through the voice coil 316, current passing through the voice coil 316 interacts with the magnetic field in the magnetic gap 400. This interaction causes the voice coil 316 to oscillate in accordance with the electrical signal, and drive the combination of the cylinder 104 and diaphragm 102 to oscillate within the housing. The peak to peak up and down movement of the diaphragm 102 may be generally described as an excursion range.

There are several advantages to having two suspensions in accordance with the invention. First, a transducer with at least two surrounds may handle more power from the voice coil 316 to drive the diaphragm to a wider excursion range. With a greater excursion range, the transducer 100 may operate at lower frequencies to generate bass sound. Thus, the transducer 100 may operate as a full range loudspeaker being able to operate between low and high frequencies. Second, with two surrounds 300 and 302 coupled to the cylinder 104, the cylinder 104 may be more stable as it moves up and down in the magnetic air gap 400. In other words, with the two suspensions 300 and 302 stabilizing the cylinder 104, there may be less chance that the cylinder 104 will rock from side to side to cause a short circuit between the voice coil 316 and the pot 404.

The two surrounds may also be coupled directly to the cylinder 104. Wobbling or unintended vibrations in the diaphragm 102 may be reduced because the surround (generally made of a flexible material) is coupled to cylinder 104 rather than to the diaphragm 102. When a surround is directly coupled to the diaphragm, the flexibility of the surround may induce wobbling in the diaphragm as the combination of the diaphragm and surround oscillate up and down. The two surrounds 300 and 302, however, may be directly coupled to the cylinder 104. In this way, the cylinder 104 may firmly support the inner edges 308 and 310 of its respective surrounds 300 and 302 so that the flexibility of the surrounds has minimal influence on the diaphragm 102. In other words, the diaphragm may not wobble without the direct influence of the surrounds. It is also possible for the first surround 300 to be coupled to the diaphragm 102, while a second surround 302 is coupled to the cylinder 104.

FIG. 3 also illustrates a substantially symmetrical first surround 300 with respect to the second surround 302. The symmetry between the two surrounds 300 and 302 allows the two surrounds to act like two parallel springs, so that the spring tensions in the two surrounds can be summed. This means that the two suspensions work together to substantially minimize the distortion in the cylinder 104 because the spring constant of the two suspension members 300 and 302 are substantially similar in the up and down strokes of the cylinder 104. Conversely, a non-symmetrical pair of suspensions may cause some distortion in the movement of the cylinder 104 because the spring constant of a non-symmetrical suspension member may be different for an up stroke versus a down stroke. However, it is not necessary to have the two substantially similar suspensions to minimize distortion. The distortion may be minimized by arranging the two substantially similar surrounds in a symmetrical fashion, instead of adjusting the distortion through design of the transducer.

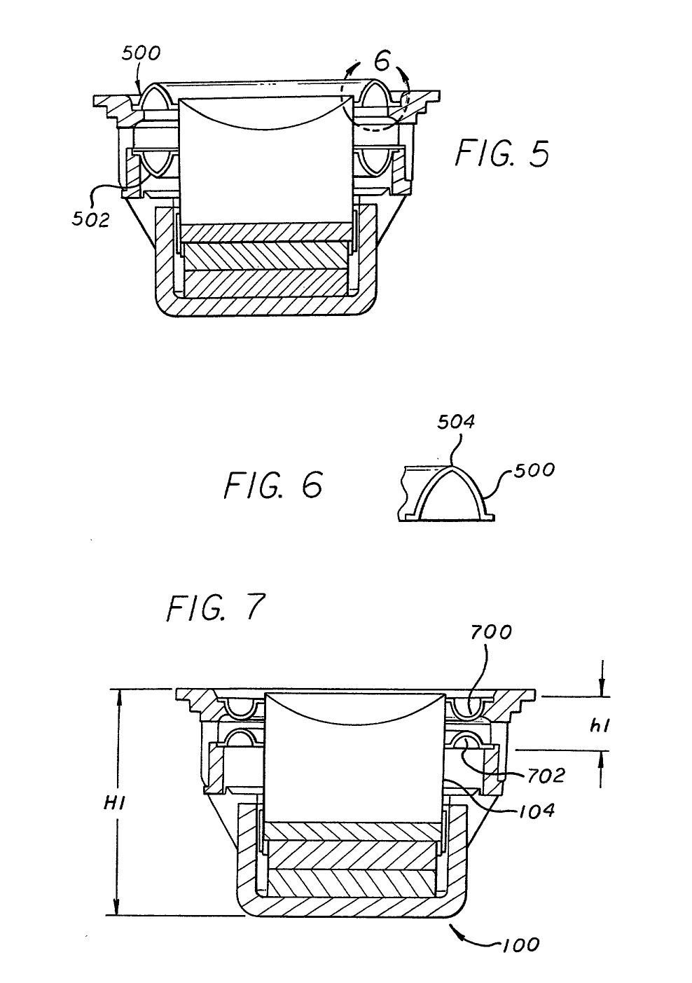

The two surrounds 300 and 302 may have a cross-section shape of 304 and 306, respectively. For example, the shape may be substantially shaped like a half-circle as illustrated in FIG. 3. However, the two surrounds may have other cross-sectional shapes. For example, as shown in FIGS. 5 and 6, the two surrounds 500 and 502 may have a shape substantially shaped like a parabolic cross-sectional shape. This allows the diaphragm 102 in the transducer 100 to have a greater excursion range because the two parabolic shape surrounds 500 and 502 may have a peak 504 that may be higher than the peak of the half-circle roll surround. With a higher peak in the surround, the cylinder 104 may have a greater range of up and down movements or greater excursion range. Thus, a smaller diameter speaker having a greater excursion range may be used as a full range loudspeaker producing a wide range of frequency sound from low to high frequencies. Alternatively, the parabolic shape surround may be used in a single surround embodiment rather than in a dual surround embodiment.

FIG. 7 illustrates another embodiment of the invention, where the two surrounds 700 and 702 are symmetrical but are inverted toward each other. There are several advantages to this arrangement. First, due to its symmetry, there may be minimal distortion in the cylinder 104 similar to tile embodiment illustrated in FIG. 3. Second, since the two surrounds are facing toward each other, rather than facing away from each other as in FIG. 3, the overall distance “H1” between the two surrounds 700 and 702 may be less than the distance between the two surrounds 300 and 302 in FIG. 3. This means that the overall height “H1” of the transducer 100 may be reduced as well. This way, the transducer 100 may be fitted into an enclosure with a small depth, such as a screen of a portable laptop computer.

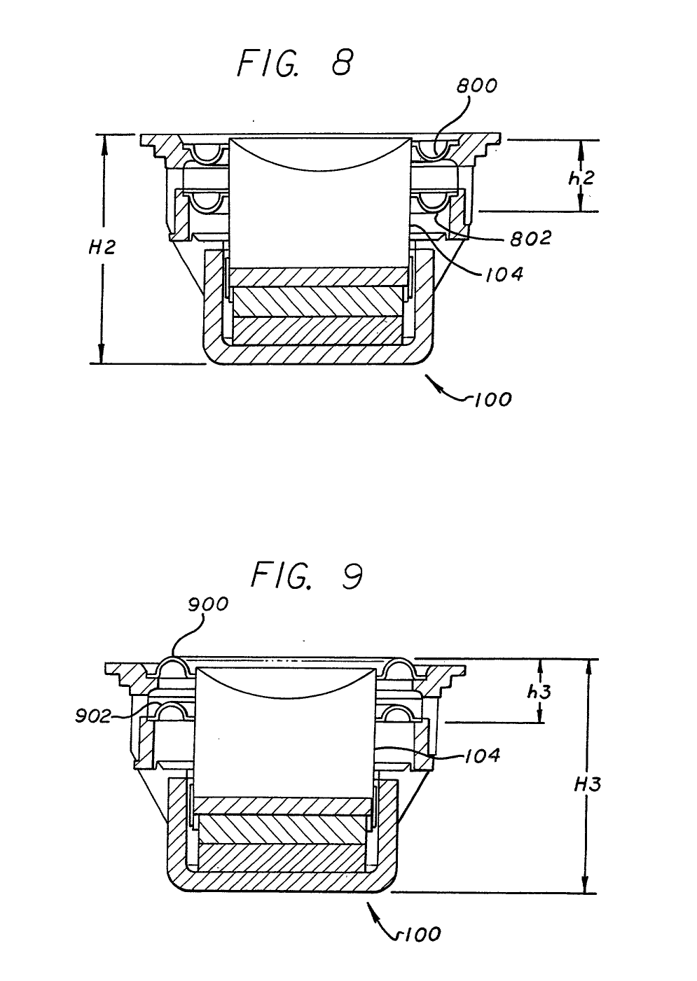

FIG. 8 illustrates two downward facing surrounds 800 and 802. This arrangement allows for a reduced “H2” of the transducer 100 between the two surrounds 800 and 802 as shown in FIG. 3. The two surrounds 800 and 802 may also be asymmetric creating some distortion in the movement of the cylinder 104. To minimize the distortion in the transducer 100, the spring constant in one of the surrounds may be adjusted to compensate for the distortion. This may be accomplished by adjusting the thickness of one of the surrounds or by using a different material for one of the surrounds with different softness characteristics. When the first surround 800 faces down, the half-circle roll may be flush within the transducer 100 further minimizing the overall depth “H2” of the transducer 100.

FIG. 9 illustrates an embodiment having two upwardly facing surrounds 900 and 902. With this arrangement, the depth “H3” of the transducer 100 may be smaller than the transducer illustrated in FIG. 3. Because the second surround 902 is facing up rather than facing down, the transducer 100 size may be minimized with respect to the transducer illustrated in FIG. 8. In other words, the depth or height “H3” maybe less than the depth “H2.”

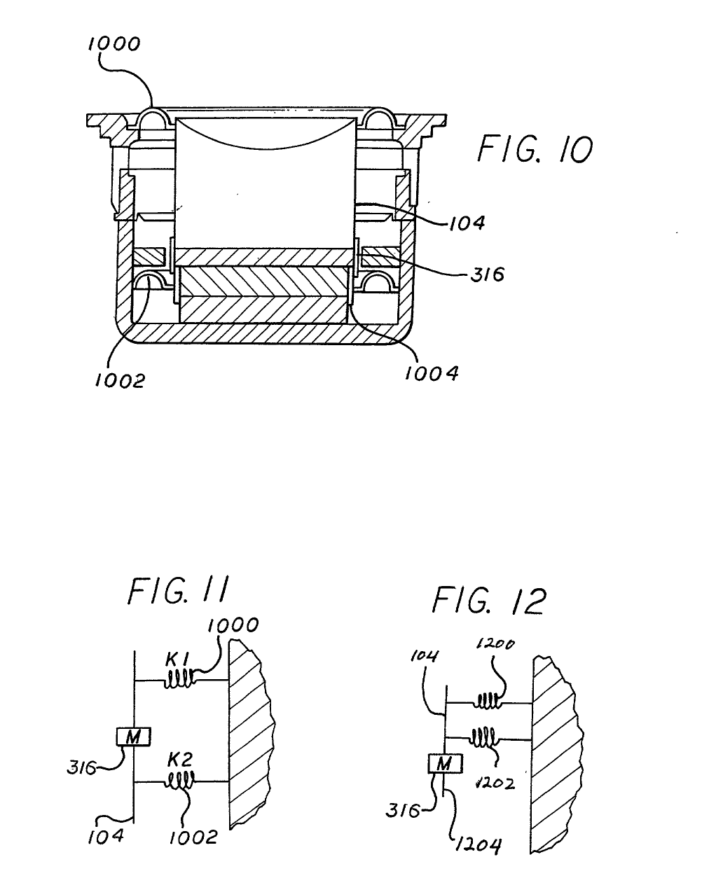

FIG. 10 illustrates the location of the voice coil 316 between the two surrounds 1000 and 1002. The cylinder 104 may be elongated to accommodate the second surround 1002 near the lower end 1004 of the cylinder 104. Alternatively, the voice coil 316 may be positioned so that the cylinder 104 may be shortened. FIG. 10 also illustrates a schematic diagram of FIG. 11, where “K1” represents the spring constant of the first surround 1000, “K2” represents the spring constant of the second surround 1002, and “M” represents the mass of the voice coil 316. An assumption may be made that the majority of the mass of both the voice coil 316 and cylinder 104 may be from the voice coil 316. In some instances, the voice coil 316 may have significantly greater mass than the cylinder 104.

One of the advantages of having the voice coil 316 located in between the two surrounds 1000 and 1002 is that it may minimize wobbling of the diaphragm for at least the following reasons. First, the two surrounds 1000 and 1002 are spaced farther apart from each so that there may be more leverage acting between the two surrounds 1000 and 1002. Second, because the center of mass is located between the two surrounds 1000 and 1002, the two surrounds may exert more leverage to control the mass M.

FIG. 12 may schematically represent the embodiments illustrated in FIGS. 3-9, where the mass M of the voice coil 316 may be near the lower end 1204 of the cylinder 104. Having the mass M located near the end 1204 may allow the cylinder 104 to wobble more freely. To minimize the wobbling, the second suspension 1202 may be positioned close as possible to the mass M. This way, the leverage the mass M has on the second suspension 1202 may be minimized so that the mass M may be more stabilized. Furthermore, the first and second suspensions 1200 and 1202 may be further apart so that the two suspensions may have more leverage to control the center mass M.

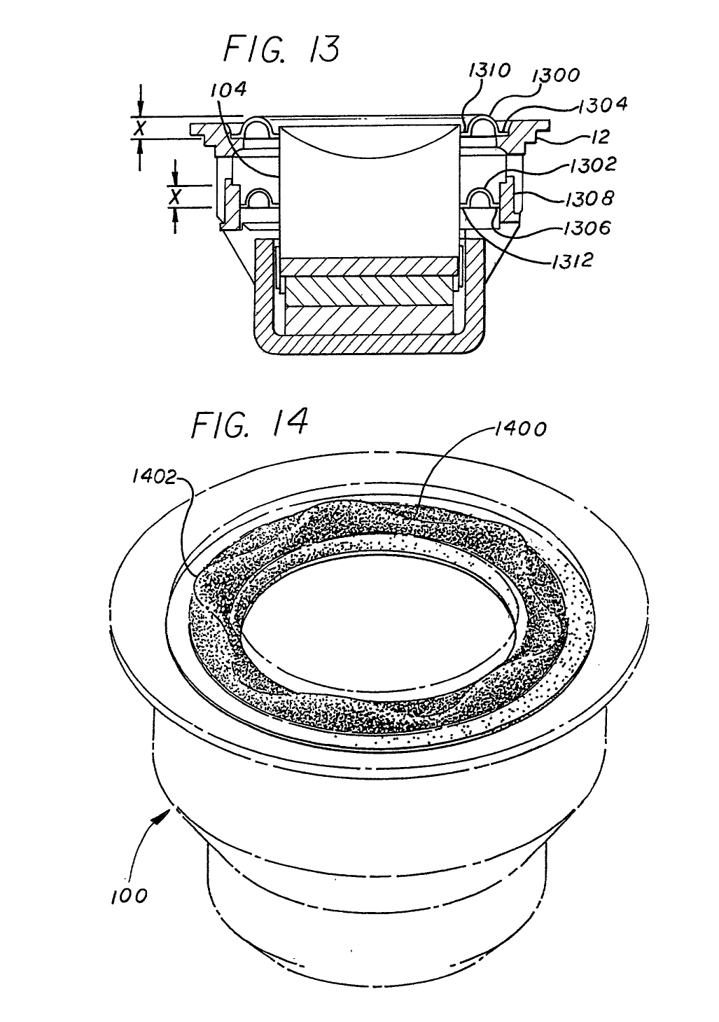

FIG. 13 illustrates the two surrounds 1300 and 1302 with its respective outer edges 1304 and 1306, coupled to the housing 1308. One of the two outer edges 1304 and 1306 may be smaller than the other. The inner edges 1310 and 1312 for the respective surrounds 1300 and 1302 may be substantially similar in order to couple to the cylinder 104. The height X of the two surrounds 1300 and 1302 may be substantially similar so that the two surrounds 1300 and 1302 may support the cylinder 104 with substantially similar excursion range.

FIG. 14 illustrates the first surround 1400 having a sinusoidal face (the second surround having a sinusoidal face not shown). The surround 1400 may have a peak 1402 that substantially forms a sine wave along the circumference of the surround 1400. This allows the surround to expand in the radial and well as in its circumference direction as the cylinder 104 oscillates up and down.

The invention may also be practiced with variations and any combination from the embodiment described above without departing from the spirit of the invention. For example, a parabolic cross-sectional surround may be used in place of a half-circular roll in any of the embodiments. In addition, the transducer 100 may have more than two surrounds.

While various embodiments of the application have been described, it will be apparent to those of ordinary skill in the art that many more embodiments and implementations are possible within the scope of this invention. Accordingly, the invention is not to be restricted except in light of the attached claims and their equivalents.

What is claimed is:

1. A transducer, comprising:
a cylinder located within a housing where the cylinder has an upper edge;
a diaphragm coupled to the upper edge of the cylinder;
a voice coil coupled to the cylinder;
a first surround having a first inner edge and a first outer edge, where the first inner edge is coupled to the cylinder and the first outer edge is coupled to the housing; and
a second surround having a second inner edge and a second outer edge, where the second inner edge is coupled to the cylinder and the second outer edge is coupled to the housing, and where the first and second inner edges of the first and second surrounds are coupled to the cylinder between the diaphragm and the voice coil.

2. The transducer according to claim 1, where the first and second surrounds are substantially similar in shape.

3. The transducer according to claim 1, where the first surround has a first outer diameter and the second surround has a second outer diameter, where the first outer diameter is greater than the second outer diameter.

4. The transducer according to claim 1, where the voice coil has a pair of lead wires extending out of the housing between the first and second surrounds.

5. The transducer according to claim 1, where the first and second surrounds face up.

6. The transducer according to claim 1, where the first and second surrounds face down.

7. The transducer according to claim 1, where the first and second surrounds face away from each other.

8. The transducer according to claim 1, where the first and second surrounds face toward each other.

9. A transducer, comprising:
a cylinder within a housing;
a first surround between the cylinder and the housing, where the first surround is coupled to the cylinder and the housing; and
a second surround between the cylinder and the housing, where the second surround is at a predetermined distance from the first surround and is coupled to the cylinder and the housing.

10. The transducer according to claim 9, further including a lead wire running between the first and second surrounds.

11. The transducer according to claim 9, further including a voice coil coupled to the cylinder.

12. The transducer according to claim 11, where the voice coil is located between the first and second surrounds.

13. The transducer according to claim 11, where the second surround is located between the first surround and the voice coil.

14. The transducer according to claim 9, further comprising a diaphragm coupled to an upper edge of the cylinder.

15. The transducer according to claim 9, where the cylinder has a circular cross-section.

16. The transducer according to claim 9, where the first and second surrounds have a half-circle roll.

17. The transducer according to claim 9, where the first and second surrounds substantially have a parabolic cross-sectional shape roll.

18. The transducer according to claim 9, where the first surround is substantially similar to the second surround.

19. The transducer according to claim 9, where the first surround is substantially symmetrical to the second surround.

20. The transducer according to claim 9, where the first surround is non-symmetrical to the second surround.

21. The transducer according to claim 9, where the first surround has a first roll, and the second surround has a second roll, where the first roll faces down and the second roll faces up.

22. The transducer according to claim 9, where the first surround has a first roll, and the second surround has a second roll, where the first and second rolls face up.

23. The transducer according to claim 9, where the first surround has a first roll, and the second surround has a second roll, where the first and second rolls face down.

24. The transducer according to claim 9, where the first surround has a first roll, and the second surround has a second roll, where the first roll faces up and the second roll faces down.

25. The transducer according to claim 9, where the second surround has a smaller outer diameter than the first surround.

26. The transducer according to claim 9, where the second surround is made of different material than the first surround.

27. The transducer according to claim 9, where the first and second surround have a sinusoidal face.

28. The transducer according to claim 9, where the first surround is coupled to a diaphragm.

29. The transducer according to claim 9, where the cylinder is made of a substantially rigid material.

30. A dual surround transducer assembly, comprising
a first surround connecting a voice coil with a housing;
a second surround connecting the voice coil with the housing; and
where the first and second surrounds are spaced apart from each other.

31. The dual surround transducer assembly of claim 30, further including a voice coil coupled to the cylinder, where the second surround is between the first surround and the voice coil.

32. The dual surround transducer assembly of claim 30, further comprising a diaphragm coupled to an upper edge of the cylinder.

33. The dual surround transducer assembly of claim 30, where the first and second surrounds are substantially similar.

34. The dual surround transducer assembly of claim 30, where the first and second surrounds have a half-circle cross-sectional shape roll.

35. The dual surround transducer assembly of claim 30, where the first and second surrounds have a parabolic cross-sectional shape roll.

36. The dual surround transducer assembly of claim 30, where the first and second surround members have a sinusoidal face.

37. The dual surround transducer assembly of claim 30, where the two surrounds face up.

38. The dual surround transducer assembly of claim 30, where the two surrounds face down.

39. The dual surround transducer assembly of claim 30, where the two surrounds face towards each other.

40. The dual surround transducer assembly of claim 30, where the two surrounds face away from each other.
